(19) United States
(12) Patent Application Publication
(10) Pub. No.: US 2017/0351640 A1
(43) Pub. Date: Dec. 7, 2017

(54) STANDARDIZED RETIMER

(71) Applicant: Intel Corporation, Santa Clara, CA (US)

(72) Inventors: Manisha Nilange, Portland, OR (US); Steven K. Krooswyk, Cayce, CA (US); Ernesto Rosales Galvan, Guadalajara (MX); Antonio Orozco Ramirez, Zapopan (MX); Daniel S. Froelich, Portland, OR (US); Mohiuddin M. Mazumder, San Jose, CA (US)

(73) Assignee: Intel Corporation, Santa Clara, CA (US)

(21) Appl. No.: 15/612,209

(22) Filed: Jun. 2, 2017

Related U.S. Application Data
(60) Provisional application No. 62/345,450, filed on Jun. 3, 2016.

(51) Int. Cl. G06F 15/78; G06F 13/40; G06F 13/42

(52) U.S. Cl. CPC G06F 15/7814; G06F 13/4291; G06F 13/4068; G06F 2213/0026

(57) ABSTRACT

A retimer device is presented with a retimer with an array of connectors on a surface of the device that are configured to form a ball grid array to electrically connect the chip package to a circuit board. At least a portion of the connectors in the array are arranged on the surface in a hexagonal pattern. The connectors are assigned to the plurality of high speed connectors to arrange each high speed differential pair in the plurality of high speed differential pairs substantially orthogonally with respect to one or more other differential pairs in the plurality of high speed differential pairs.

This application claims benefit to U.S. Provisional Patent Application Ser. No. 62/345,450, filed Jun. 3, 2016 and incorporated by reference herein in its entirety.

### FIELD

This disclosure pertains to computing system, and in particular (but not exclusively) to retimer devices in point-to-point interconnects.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc.

As a result of the greater ability to fit more processing power in smaller packages, smaller computing devices have increased in popularity. Smartphones, tablets, ultrathin notebooks, and other user equipment have grown exponentially. However, these smaller devices are reliant on servers both for data storage and complex processing that exceeds the form factor. Consequently, the demand in the high-performance computing market (i.e. server space) has also increased. For instance, in modern servers, there is typically not only a single processor with multiple cores, but also multiple physical processors (also referred to as multiple sockets) to increase the computing power. But as the processing power grows along with the number of devices in a computing system, the communication between sockets and other devices becomes more critical.

In fact, interconnects have grown from more traditional multi-drop buses that primarily handled electrical communications to full blown interconnect architectures that facilitate fast communication. Unfortunately, as the demand for future processors to consume at even higher-rates corresponding demand is placed on the capabilities of existing interconnect architectures.

### BRIEF DESCRIPTION OF THE DRAWINGS

FIG. 1 illustrates an embodiment of a computing system including an interconnect architecture.

FIG. 2 illustrates an embodiment of a interconnect architecture including a layered stack.

FIG. 3 illustrates an embodiment of a request or packet to be generated or received within an interconnect architecture.

FIG. 4 illustrates an embodiment of a transmitter and receiver pair for an interconnect architecture.

FIGS. 5A-5C illustrate simplified block diagrams of example implementations of a test mode for determining errors in one or more sublinks of a link.

FIGS. 6A-6B illustrate simplified block diagrams of example links including one or more extension devices.

FIG. 7 illustrates a simplified block diagram of an example riser card.

FIG. 8 illustrates a simplified block diagram of a portion of a circuit board.

FIG. 9 illustrates a simplified block diagram of an example riser card incorporating an improved retimer design.

FIGS. 10A-10B are diagrams representing pin assignment within a pinfield of a standardized ×4 retimer.

FIG. 11 is a diagram representing pin assignment within a pinfield of a standardized ×8 retimer.

FIGS. 12A-12B show a diagram representing pin assignment within a pinfield of a standardized ×16 retimer.

FIG. 13 is a diagram illustrating a hexagonal pin arrangement within a retimer.

FIG. 14 is a diagram illustrating crosstalk within a grid-based pinfield pattern.

FIG. 15 is a diagram illustrating crosstalk within a hexagonal pinfield pattern using orthogonal arrangement of differential signaling pairs.

FIG. 16 is a graph illustrating crosstalk improvement of an example hexagonal pinfield pattern relative to an example grid-based pinfield pattern.

FIG. 17 illustrates an embodiment of a block diagram for a computing system including a multicore processor.

FIG. 18 illustrates another embodiment of a block diagram for a computing system including a multicore processor.

FIG. 19 illustrates an embodiment of a block diagram for a processor.

FIG. 20 illustrates another embodiment of a block diagram for a computing system including a processor.

FIG. 21 illustrates an embodiment of a block for a computing system including multiple processors.

FIG. 22 illustrates an example system implemented as system on chip (SoC).

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or UltrabooksTM. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot- Swap support, Data Integrity, and Error Handling are among some of the advanced features supported by PCI Express.

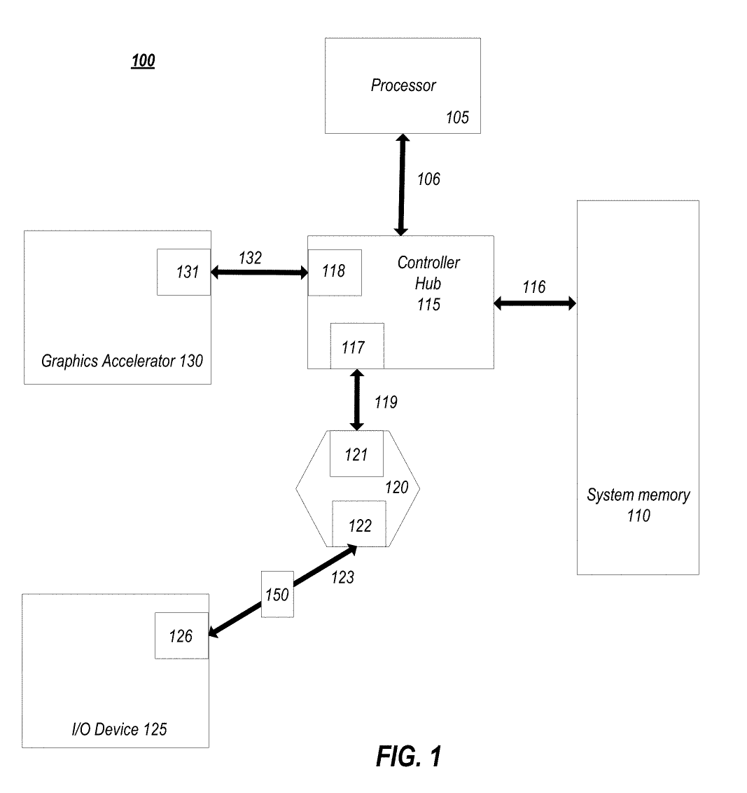

Referring to FIG. 1, an embodiment of a fabric composed of point-to-point Links that interconnect a set of components is illustrated. System 100 includes processor 105 and system memory 110 coupled to controller hub 115. Processor 105 includes any processing element, such as a microprocessor, a host processor, an embedded processor, a co-processor, or other processor. Processor 105 is coupled to controller hub 115 through front-side bus (FSB) 106. In one embodiment, FSB 106 is a serial point-to-point interconnect as described below. In another embodiment, link 106 includes a serial, differential interconnect architecture that is compliant with different interconnect standard.

System memory 110 includes any memory device, such as random access memory (RAM), non-volatile (NV) memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in a Peripheral Component Interconnect Express (PCIe or PCIE) interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 105, while controller 115 is to communicate with I/O devices, in a similar manner as described below. In some embodiments, peer-to-peer routing is optionally supported through root complex 115.

Here, controller hub 115 is coupled to switch/bridge 120 through serial link 119. Input/output modules 117 and 121, which may also be referred to as interfaces/ports 117 and 121, include/implement a layered protocol stack to provide communication between controller hub 115 and switch 120. In one embodiment, multiple devices are capable of being coupled to switch 120.

Switch/bridge 120 routes packets/messages from device 125 upstream, i.e. up a hierarchy towards a root complex, to controller hub 115 and downstream, i.e. down a hierarchy away from a root controller, from processor 105 or system memory 110 to device 125. Switch 120, in one embodiment, is referred to as a logical assembly of multiple virtual PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a PCIe to PCI/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly I/O device 125, is then coupled to the ICH. I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105. Further, one or more links (e.g., 123) of the system can include one or more extension devices (e.g., 150), such as retimers, repeaters, etc.

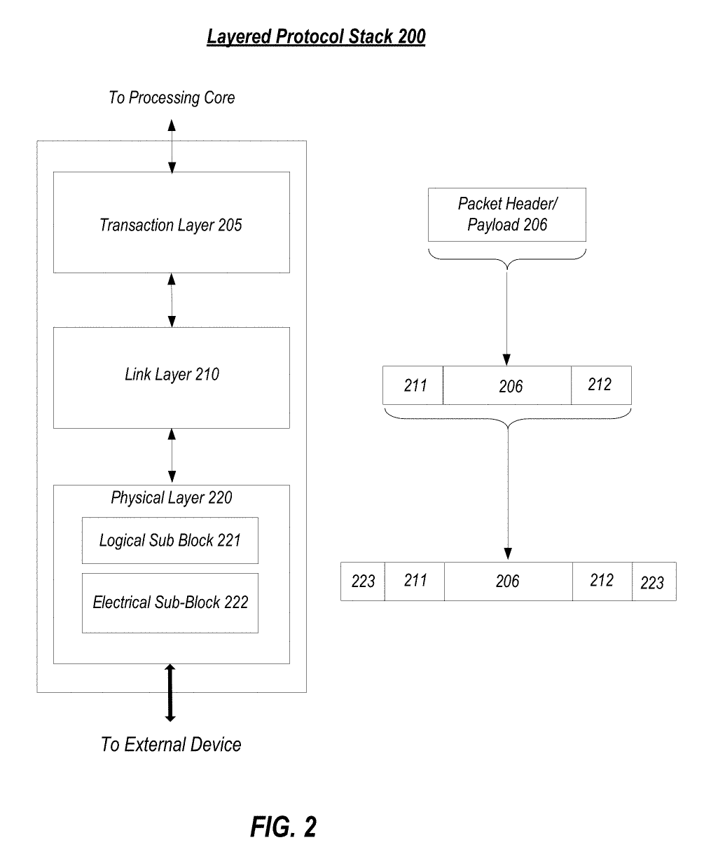

Turning to FIG. 2 an embodiment of a layered protocol stack is illustrated. Layered protocol stack 200 includes any form of a layered communication stack, such as a Quick Path Interconnect (QPI) stack, a PCIe stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (i.e., transaction layer packets, or TLPs). The translation layer 205 typically manages credit-base flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 205 assembles packet header/payload 206. Format for current packet headers/payloads may be found in the PCIe specification at the PCIe specification website.

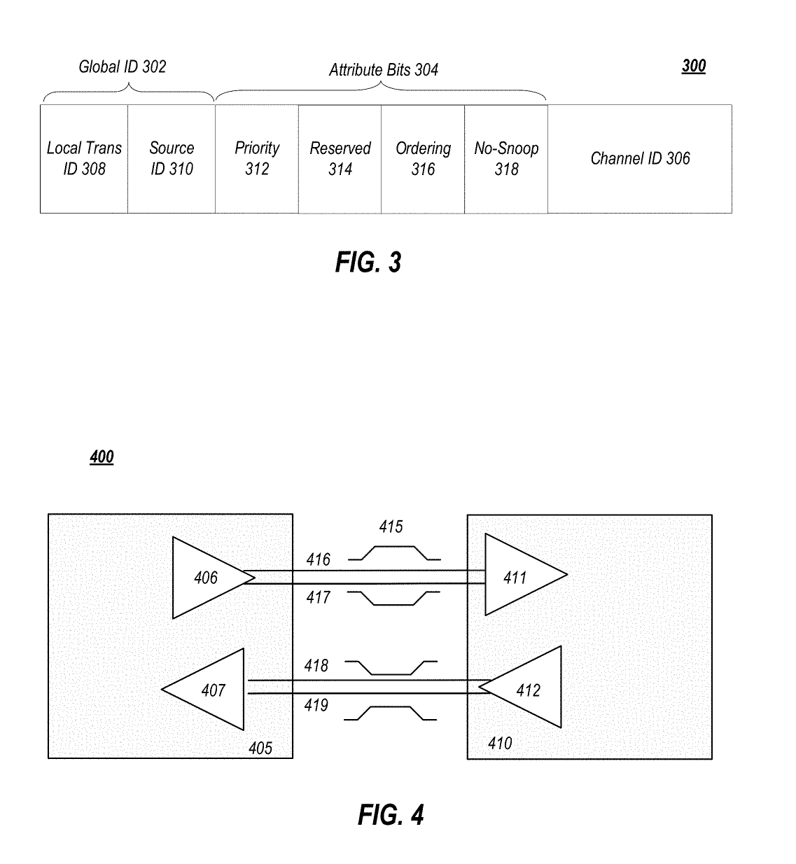

Quickly referring to FIG. 3, an embodiment of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global transaction identifier 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority sub-field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 318 is utilized to determine if transactions are snooped. As shown, channel ID Field 306 identifies a channel that a transaction is associated with.

Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, i.e. an identification number or packet number, calculates and applies an error detection code, i.e. CRC 212, and submits the modified TLPs to the Physical Layer 220 for transmission across a physical to an external device.

Physical Layer

In one embodiment, physical layer 220 includes logical sub block 221 and electrical sub-block 222 to physically transmit a packet to an external device. Here, logical sub-block 221 is responsible for the “digital” functions of Physical Layer 221. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8b/10b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/411 and a receive pair 412/407. Accordingly, device 405 includes transmission logic 406 to transmit data to device 410 and receiving logic 407 to receive data from device 410. In other words, two transmitting paths, i.e. paths 416 and 417, and two receiving paths, i.e. paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane—each lane representing a set of differential signal pairs (one pair for transmission, one pair for

P99497 reception). To scale bandwidth, a link may aggregate multiple lanes denoted by xN, where N is any supported Link width, such as 1, 2, 4, 8, 12, 16, 32, 64, or wider.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

In some implementations, a link, such as a PCIe-compliant link, can include one or more retimers or other extension devices, such as a repeater. A retimer device (or simply “retimer”), can include active electronic devices that receive and re-transmit (retime) digital I/O signals. Retimers can be used to extend the length of a channel that can be used with a digital I/O bus. Retimers can be protocol aware, software transparent, and capable of executing a link equalization procedure, such as the link equalization procedure of PCIe.

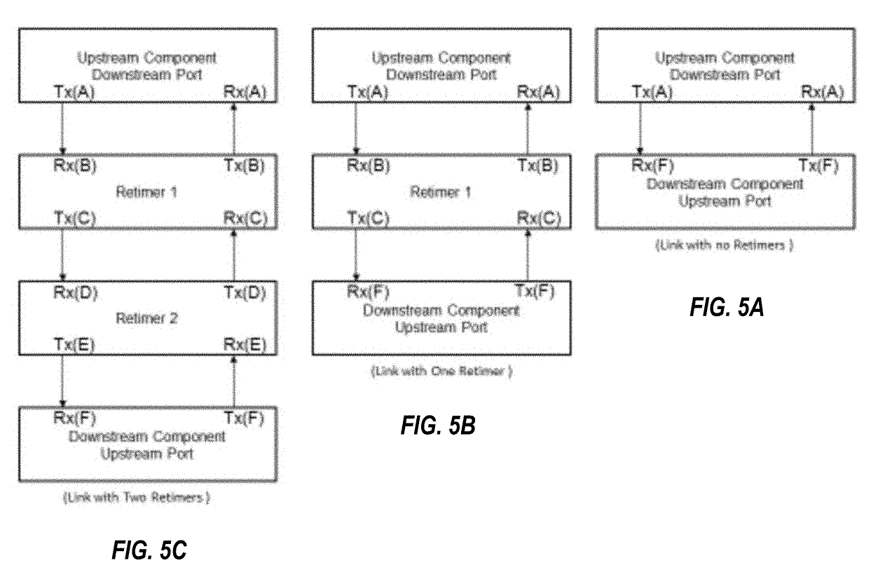

FIGS. 5A-5C are simplified block diagrams 500a-c illustrating example implementations of a link interconnecting two system components, or devices, such as upstream component 505 and downstream component 510. An upstream component 505 and downstream component 510 can be connected directly, in some instances, with no retimers, redrivers, or repeaters disposed on the link between the two components 505, 510, such as shown in the example of FIG. 5A. In other instances, a retimer (e.g., 515) can be provided to extend the link connecting upstream component 505 and downstream component 510. such as illustrated in FIG. 5B. In still other implementations, two or more retimers (e.g., 515, 520) can be provided in series to further extend a link connecting upstream component 505 and downstream component 510. For instance, a particular interconnect technology or protocol may specify a maximum channel length and one or more retimers (e.g., 515, 520), can be provided to extend the physical length of the channel connecting two devices 505, 510. For instance, providing retimers 515, 520 between upstream component 505 and downstream component 510 can allow a link three times the maximum length specified for a link without these retimers e.g., 515, 520, among other example implementations.

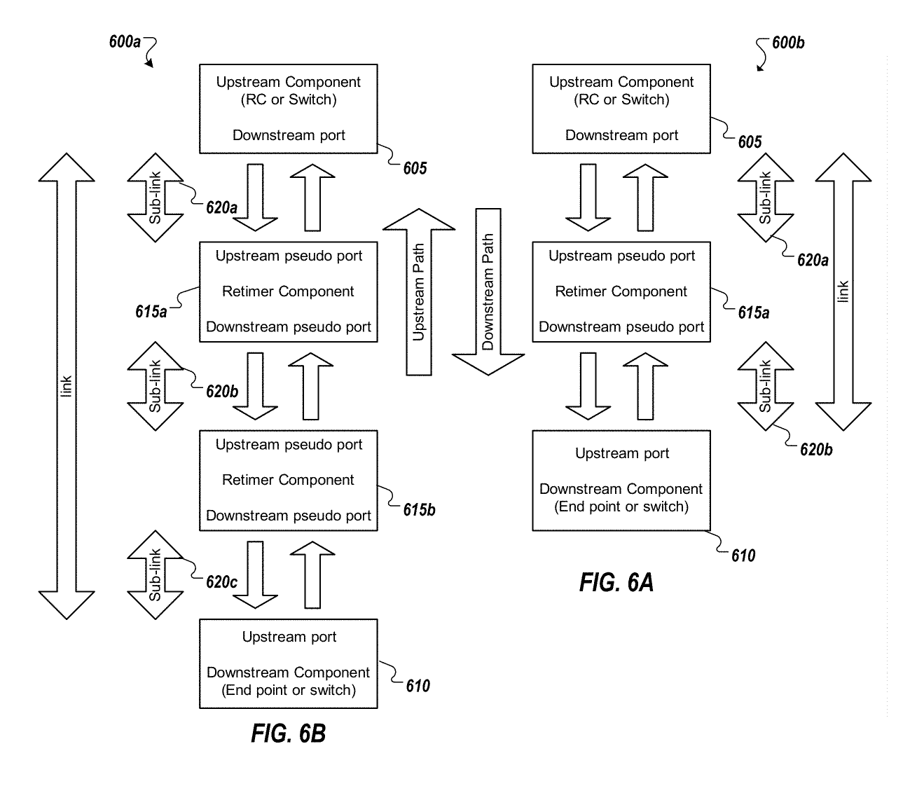

A link incorporating one or more retimers can form two or more separate electrical sub-links at data rates comparable to data rates realized by links employing similar protocols but with no retimers. For instance, a link including a single retimer can form a link with two separate sub-links, each operating at 8.0 GT/s or higher. FIGS. 6A-6B illustrate simplified block diagrams 600a-b of example links including one or more retimers. For instance, in FIG. 6A, a link connecting a first component 605 (e.g., an upstream component) to a second component 610 (e.g., a downstream component) can include a single retimer 615a. A first sublink 620a can connect the first component 605 to the retimer 615a and a second sublink 620b can connect the retimer 615a to the second component. As shown in FIG. 6B, multiple retimers 615a, 615b can be utilized to extend a link. Three sublinks 620a-c can be defined through the two retimers 615a, 615b, with a first sublink 615a connecting the first component to the first retimer 615a, a second sublink connecting the first retimer 615a to the second retimer 615b, and the third sublink 615c connecting the second retimer 615b to the second component.

As shown in the examples of FIGS. 6A-6B, in some implementations, a retimer can include two pseudo ports, and the pseudo ports can determine their respective downstream/upstream orientation dynamically. Each retimer 615a, 615b can have an upstream path and a downstream path. Further, retimers 615a, 615b can support operating modes including a forwarding mode and an executing mode. A retimer 615a, 615b in some instances can decode data received on the sub-link and re-encode the data that it is to forward downstream on its other sublink. As such, retimers may capture the received bit stream prior to regenerating and re-transmitting the bit stream to another device or even another retimer (or redriver or repeater). In some cases, the retimer can modify some values in the data it receives, such as when processing and forwarding ordered set data. Additionally, a retimer can potentially support any width option as its maximum width, such as a set of width options defined by a specification such as PCIe.

As data rates of serial interconnects (e.g., PCIe, UPI, USB, etc.) increase, retimers are increasingly used to extend the channel reach. Multiple retimers can be cascaded for even longer channel reach. It is expected that as signal speeds increase, channel reach will typically decrease as a general matter. Accordingly, as interconnect technologies accelerate, the use of retimers may become more common. As an example, as PCIe Gen-4, with its 16 GT/s, is adopted in favor of PCIe Gen-3 (8 GT/s), the use of retimers in PCIe interconnects may increase, as may be the case in other interconnects as speeds increase.

In one implementation, a common BGA (Ball Grid Array) footprint may be defined for PCI Express Gen-4 (16 GT/s) based retimers. Such a design may address at least some of the example shortcomings found in conventional PCIe Gen-3 (8 GT/s) retimer devices, as well as some of the issues emerging with the adoption of PCIe Gen-4. Further, for PCIe Gen-4, the number of retimer vendors and volume are expected to increase. Due to signal losses from the doubled data rate (from 8 GT/s to 16 GT/s), the interconnect length achievable is significantly decreased in Gen-4. In this and other example interconnect technologies, as data rate increases, retimers may thereby have increased utility as they can be used to dramatically increase channel lengths that would be otherwise constrained by the increased data rate.

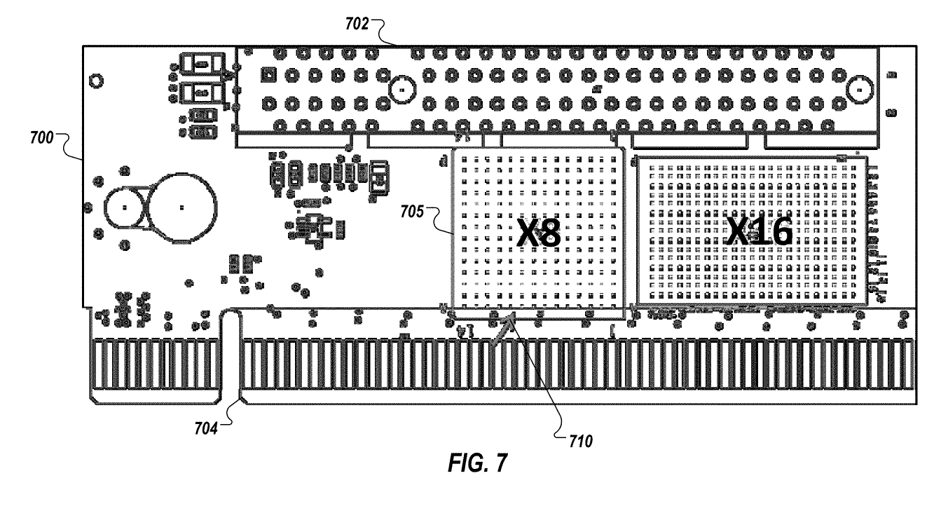

Traditional retimers have suffered from a number of shortcomings. For instance, the package size of traditional PCIe retimers has been too large for the PCIe Riser in some implementations. Similar space constraints may challenge the adoption of retimers in other (i.e., non-PCIe) interconnects. Accordingly, retimers may be designed to define standardized, smaller package design. As an example, shown in FIG. 7, an example a system may utilize a riser card or board (e.g., 700) constrained by a fixed height between a slot 702 (e.g., a PCIe slot) and right-angle connector 704 (e.g., a PCIe connector). In some examples, the ×8 (8 lanes) of traditional PCIe retimers may sometimes fail to fit on the riser 700 as it exceeds the manufacturing component keep out zone (with the example ×8 retimer (705) falling outside of the zone as shown by the arrow 710).

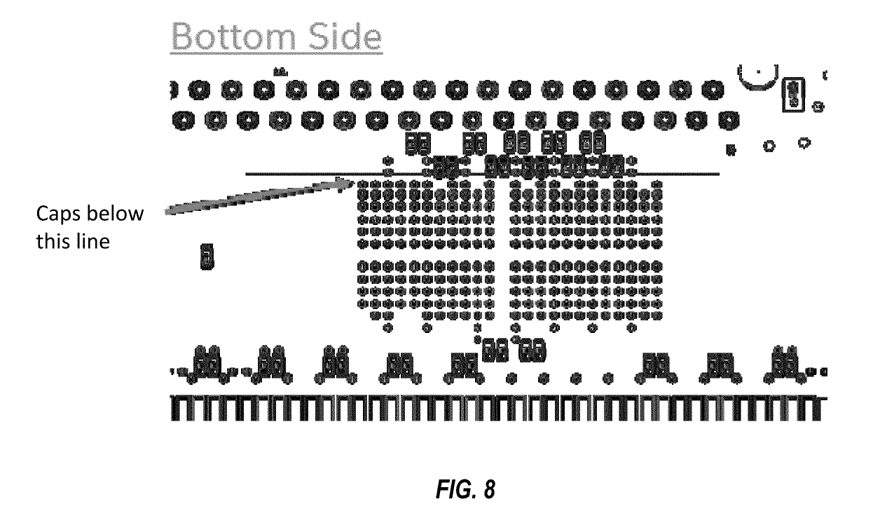

As another example, alternating current (AC) coupling capacitors cannot be placed on a riser in some traditional retimer implementations. A “narrow” footprint design and optional on-package capacitor placement can be utilized to address this shortcoming. For instance, in the case of PCIe cars, while it may be possible to place a conventional ×16 (16 lanes) retimer part on the riser, generally there is not enough remaining space allocated for AC coupling capacitors. Such capacitors, however, may be required (e.g., by the PCIe specification) to be located between the device transmitter and the connector, further constraining the design. The space constraint is shown in the example illustrated in FIG. 8.

As another example issue, conventional retimer pinmaps have struggled to maintain acceptable crosstalk characteristics. For instance, signal to signal crosstalk at 16 GT/s is excessive in both ×8 and ×16 conventional grid-based retimer pinmaps. An improved pinmap can be adopted to optimize a defined retimer for higher speeds while ensuring that trace lengths remain under maximum allowed lengths. Indeed, an improved retimer pinmap can result in steep reduction of differential signal crosstalk.

In the case of PCIe, package sizes of conventional PCIe retimers have negatively affected usage opportunities and adoption. For instance, some conventional PCIe retimer packages have different heights and widths depending on the number of lanes, creating different layout requirements based on the selection. The resulting dimensions of some of these designs may limit their adoption in PCIe (or other) interconnects. For instance, in one example, only the x8 design of a retimer may be capable of being physically placed on a 1U riser without violating manufacturing keep out zones. Further, such differentiated designs may also drive complexity, higher cost, and prevent second-sourcing. For instance, for PCIe Gen-3, retimer cost is high relative to other system interfaces. Continued differentiation for PCIe Gen-4 may continue to lead to higher costs, effecting original equipment manufacturer (OEM) bottom lines, and thereby hindering health of the PCIe ecosystem generally. For instance, it can be difficult for an OEM to change supplier in case of a supply chain issue or validation debug hurdles as the platform needs to be laid out specifically for the selected vendor's pinout. At the introduction of a new technology such as PCIe Gen-4, vendor product issues are probable and could thus prevent customer shipment. PCIe Gen-4 retimer designs are expected to differentiate in (a) footprint, (b) control bus, and (c) voltage rail. Such diversity of design threatens to lead to completely different, non-overlapping pinouts across multiple SKUs of a retimer, forcing OEMs to layout the board differently for each retimer SKU, further increasing cost and complicating the design process. Indeed, significant differences in pinout drives significant design SKUs across riser form-factors and port width.

In one implementation, a standardized retimer footprint can be defined (e.g., in a corresponding specification) for an entire class of interconnect technologies (e.g., PCIe, QPI, USB, UPI, SATA, MIPI PHY, etc.). For instance, an example PCIe retimer standardization may be defined to be applied to all PCIe retimers of all lane sizes. Corresponding retimer standardization may be defined for the various lane sizes supported in other technologies. In one example, a standardized retimer footprint can be defined, which keeps one dimension (e.g. height) consistent across all (e.g., ×4, ×8, and ×16) footprints, thereby simplifying the process of designing to accommodate any potential retimer lane size, including height constrained form factors, such as the 1U and 2U risers. The standardized footprint can define, for each package size, all signal pin locations such as high-speed data, power, ground, and control interface.

A standardized footprint may further address concerns including package size, crosstalk, and capacitor placement in space-constrained form-factors. For instance, a standardized retimer can adopt a common pinout that reduces the number of pins and pin concentration to thus reduce the overall package area significantly compared to conventional designs while preserving or even improving upon the performance characteristics of the retimer. In one example, from a conventional design to the improved design, the pin count (for a footprint with a BGA at a 400 mA/ball current profile) may be reduced from 345 to 297 pins for 16-lanes, and 196 to 176 pins for 8-lanes (and may be further reduced for BGAs with higher current profiles (e.g., 100 mA/ball)). The package area can thereby also be reduced from 260 mm² to 180 mm² for an 16-lane implementation (a 41% area reduction), from 225 mm² to 102 mm² for an 8-lane implementation (an 111% area reduction), and from 81 mm² to 64 mm² (a 19% area reduction) for a 4-lane implementation. Overall board area can thereby be reduced. In one implementation, board area is further reduced by specifying AC coupling capacitors to be placed within the package design.

In one implementation, a standardized retimer design can additionally reduce the number of BGA ball power pins by 59 for 16-lane pinout, 26 for 8-lane pinout and 12 for 4-lane pinout. For instance, the standardized retimer design may utilize a “balls anywhere” design for solderball placement. This may allow the assignment of signal lanes within the pinmap according to hexagonal, as opposed to the tradition grid/square pattern. Hexagonal placement may reduce the package size significantly for the same number of pins as a grid/square design. In one implementation of a hexagonal pattern, connectors in any given row of connectors are not aligned vertically with immediately adjacent rows in the pattern and connectors in any given column of connectors will not be aligned horizontally with the connectors of columns immediately adjacent to it. Further, hexagonal pin placement can permit tighter layouts, allowing a lower pin/surface area than conventional grid-based BGA patterns. Additionally (e.g., as shown in FIG. 15), hexagonal pin placement also enables an orthogonal arrangement of high speed signals pairs that may reduce crosstalk by 5 dB at 8 GHz compared to conventional retimer designs, while at the same time reducing the signal-to-ground ratio and assisting in overall pin count reduction. In one implementation, at least 50% of the high-speed signals in the improved footprint may use this orthogonal crosstalk reduction technique.

As noted above, in some implementations, a standardized retimer can define footprint designs where one dimension of the package size is fixed irrespective of the number of lanes. Further, the 8 and 16 lane footprints build-up on the smaller 4 lane footprint, retaining as many pin locations as possible to make board design easier. This common footprint as a standard enables OEMs to more easily change and evaluate vendors. With multiple vendors of conventional retimers in a market, each potentially having multiple lane offerings, over a dozen possible footprints may exist increasing the difficulty for an OEM to evaluate the design. However, through such footprint standardization, the common footprint can eliminate this complexity and promote the use and implementation of retimers in developing systems.

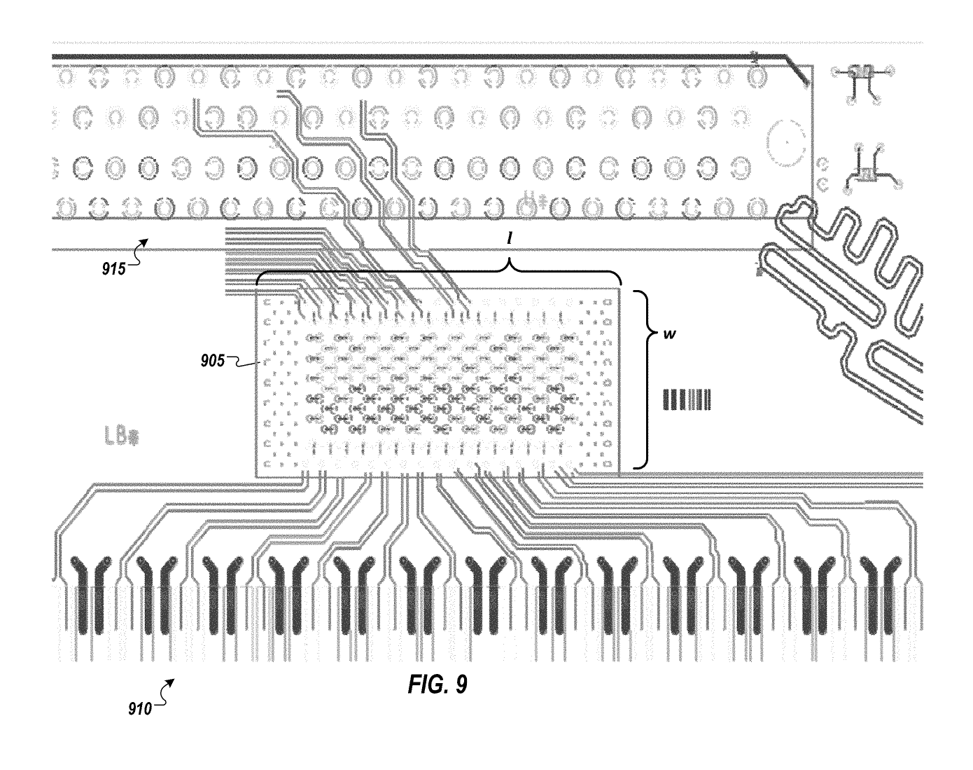

A demonstration of a standardized, reduced PCIe retimer package 905 is shown in FIG. 9 successfully placed on 1U PCIe riser. Though the ×16 variant is shown, any one of the supported footprints (e.g., 4×, 8×, 16×, etc.) would have the same width w enabling placement between the edge finger 910 and connector 915 (although the length/of each of the 4×, 8×, and 16× packages would differ). Further, capacitors may be optionally placed within the retimer package on transmit lanes. Such capacitors may meet PCIe Base Specification Revision 4.0 requirements.

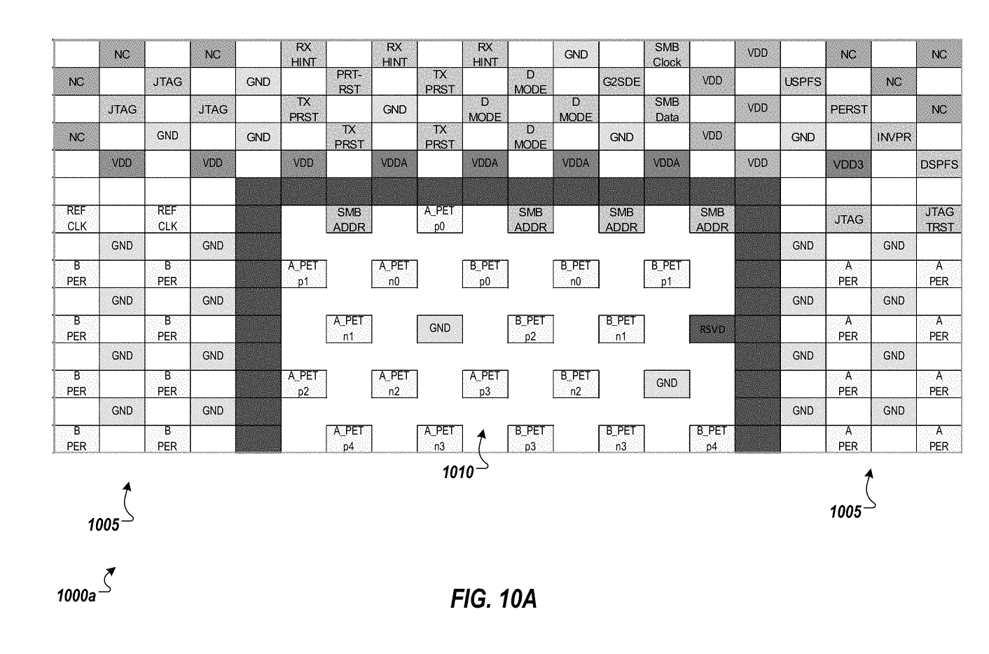

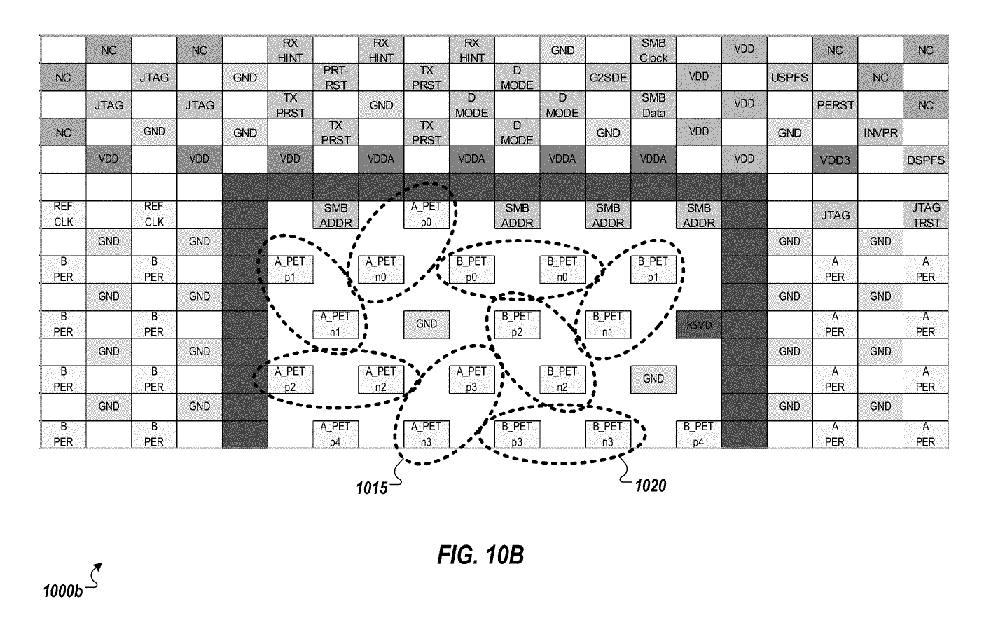

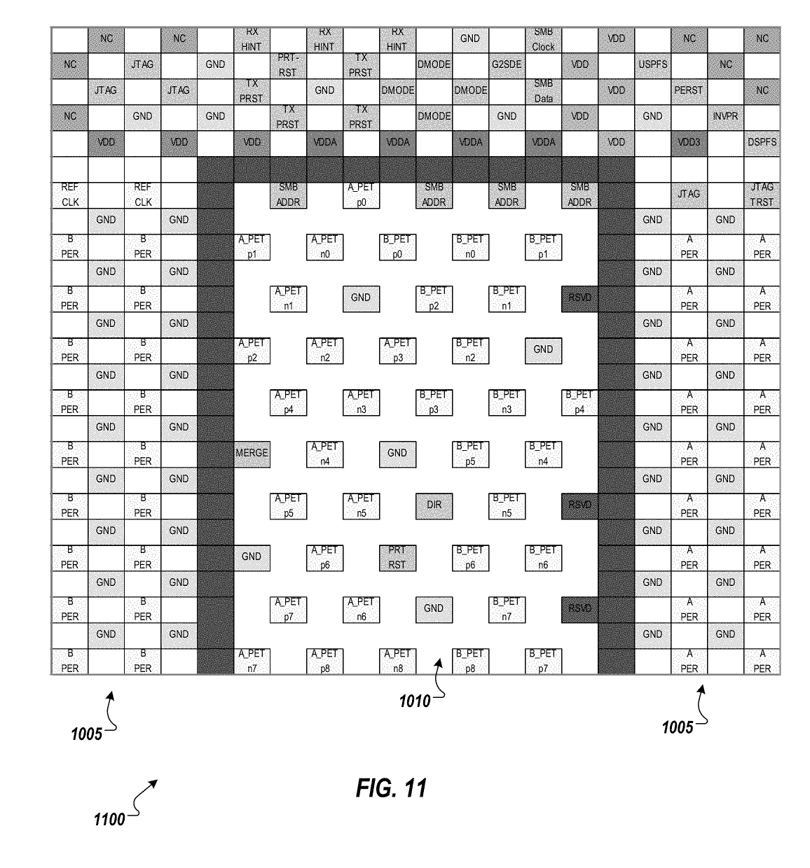

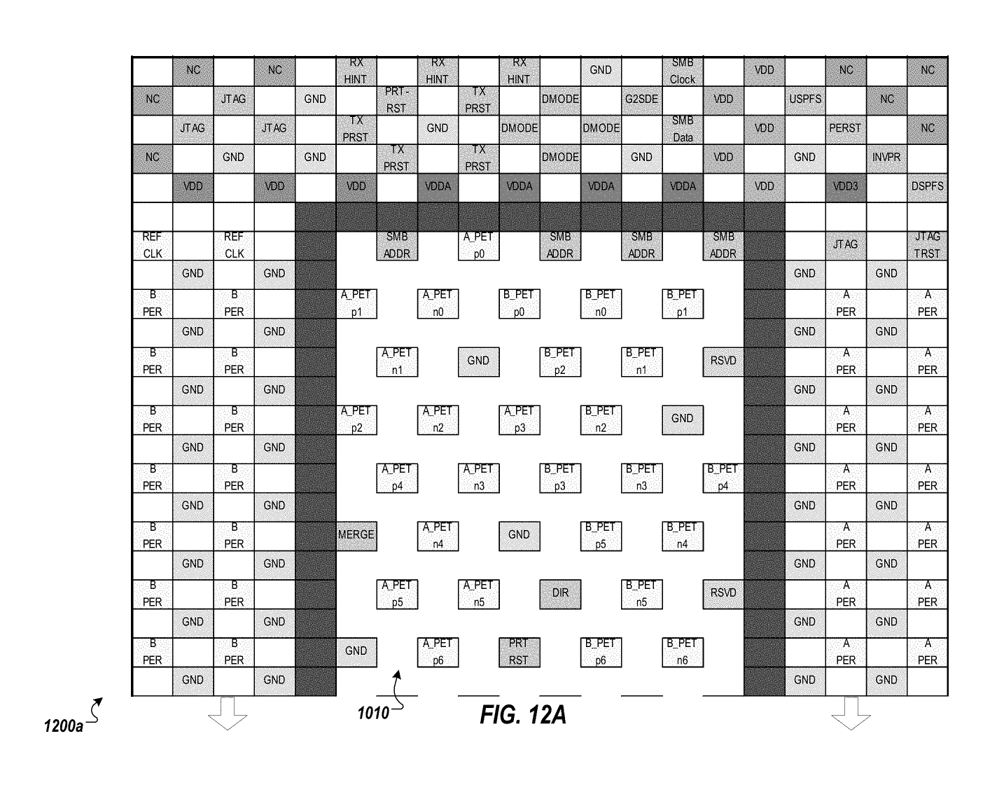

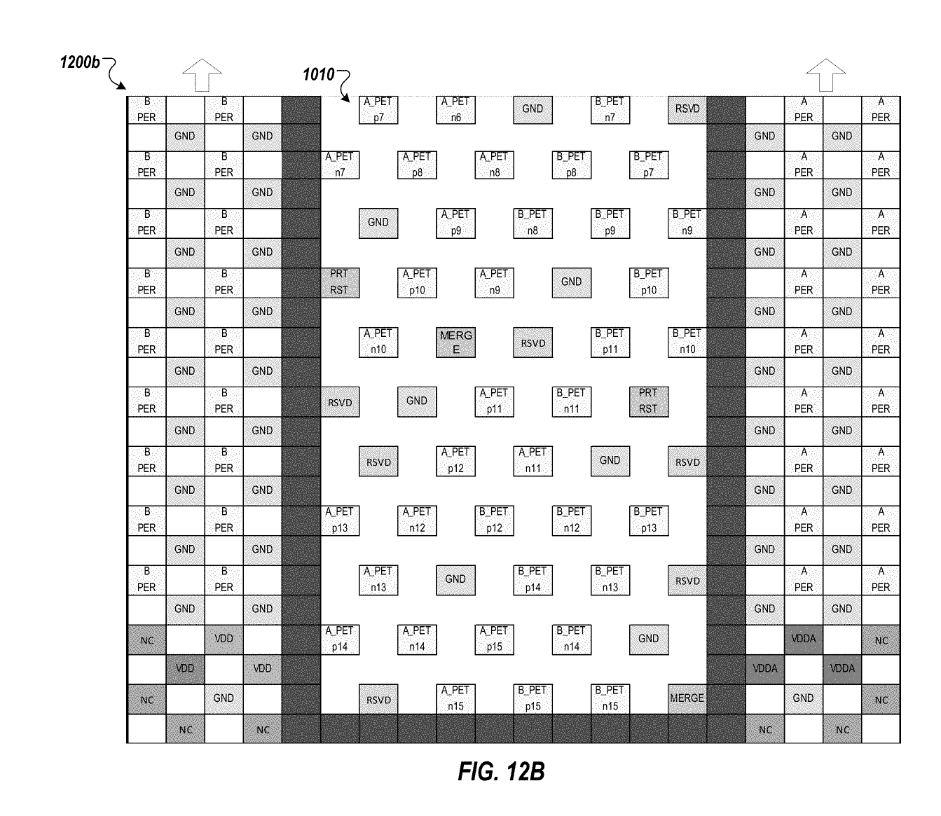

FIGS. 10A-10B, 11, and 12A-12B show the detailed signal pin locations for each of the ×4, ×8, and ×16 designs of standardized retimer footprint, such as the standardized retimer footprint defined for PCIe retimers. For instance, FIG. 10A shows a representation of an example pin layout array 1000a of an ×4 PCIe retimer. Two regions 1005, 1010 may be defined within the pin layout (or pinmap), with an outer region 1005 dedicated or mapped to pins used for signals with lower data rates, and an interior region dedicated or mapped to pins intended for signals with high data rates. For instance, in this example, the 4 lanes of high speed differential signaling pairs supported on the 4× retimer (e.g., 4 lanes on the retimer receive side (A_PET p0/n0, A_PET p1/n1, A_PET p2/n2, and A_PET p3/n3) and 4 lanes on the retimer transmit side (B_PET p0/n0, B_PET p1/n1, B_PET p2/n2, and B_PET p3/n3)) may be provided in an interior region 1010 (e.g., that is bordered on two or more sides by the outer region 1005). The pinfield pattern may provide for a hexagonal arrangement in at least the interior region 1010 (although hexagonal pinfield patterns are provided in each of the pinfield regions 1005, 1010 in this example). Further, signals may be assigned within the hexagonal pattern so as to mitigate crosstalk between high speed pins. For instance, the diagram 1000b of FIG. 10B illustrates the assignment of pins to specific high speed differential signaling pairings (e.g., 1015, 1020, etc.), such that neighboring pairings are not parallel to one another and are offset by various angles (e.g., corresponding to the angles adopted between pins in the pinfield pattern). Similar lane assignments are shown in the examples of FIGS. 11 and 12A-12B.

FIG. 11 shows an example pinfield layout 1100 and signal assignment for an ×8 retimer. In this example, as shown in FIG. 11, the pins of the ×4 retimer (shown in FIGS. 10A-10B) are reused and added to, providing an ×8 retimer with the same width as the ×4 retimer. Likewise, the combined representations 1200a-b of FIGS. 12A-12B show the detail signal pin locations for an ×16 retimer, which, too, builds upon the pin pattern of the ×4 design as well as the ×8 design to provide the ×16 design (which also has the same width as the ×4 and ×8 retimers). Additional standardized features may be provided. For instance, in each of the designs of the example standardized retimer shown in FIGS. 10A-12B, standardized features may include one or more of:
Commonality in signal pins between ×4, ×8, and ×16 for majority of signals;
An outside hexagonal pin pattern with 0.8 mm diagonal pitch;
An inside hexagonal pin pattern with 1.0 mm diagonal pitch;
Orthogonal placement of high speed differential pairs within the inside array to promote crosstalk cancelation;
Low frequency sideband signals placed adjacent to high speed differential signals instead of grounds within the array, to thereby reduce the total number of ground pins;
Reduced number of 1.0V digital, 1.0V analog, and 1.8V power pins;
Multiple ground pins located in package corner for mechanical reliability.

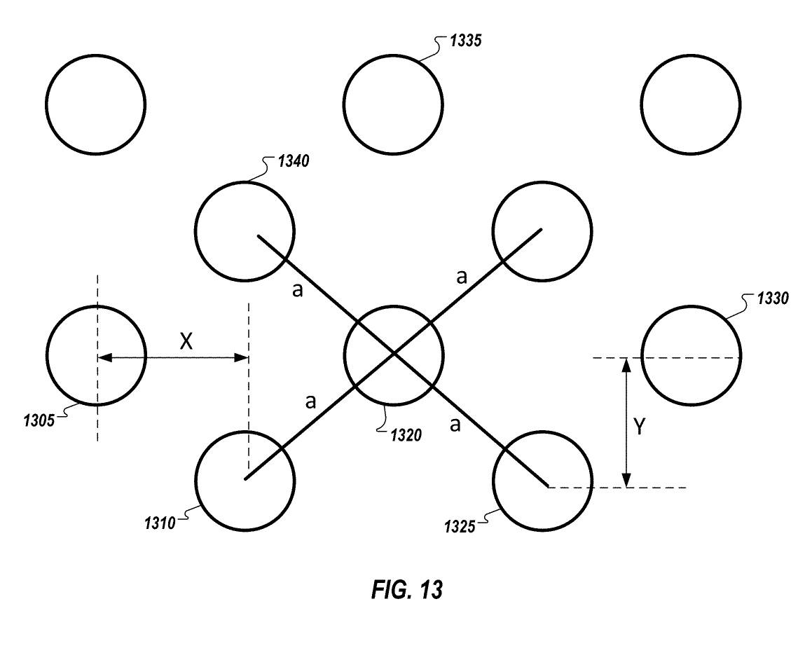

Turning to FIG. 13, a diagram is shown representing a detailed view of a portion of a pin, or connector, array of a retimer footprint, which adopts a hexagonal connector pattern (i.e., with each circle (e.g., 1305, 1310, 1315, 1320, 1330, 1335, 1340, etc.) representing a respective pin, connector, ball, etc. within the field). In one example, an array of connectors can adopt a hexagonal pattern through the retimer package's footprint. However, in some implementations, the pin density can vary within the footprint. For instance (as introduced above in the example of FIG. 10A), two or more regions (e.g., 1005, 1010) can be defined in the footprint, the first adopting a hexagonal connector pattern where the pins are positioned relative to each other at a first diagonal pitch a and another one of the regions adopting another hexagonal connector pattern where the pins are positioned according to a different, second diagonal pitch a. As shown in the example of FIGS. 10-12B, one region can correspond to an outside region that incorporates a portion of the retimer pinfield nearest to two or more of the edges of the footprint, while a second inside, or interior, region corresponds to connectors nearer to the middle of the pinfield (and at least partially framed by the outside region). In one example, pins in the outside region can be positioned more closely together than in the interior region (e.g., as vias may be needed for pins closer to the center of the pinfield given crosstalk or other considerations). In one example:
Outside Pattern: a=0.8 mm, x=0.508 mm (31.5 mils), y=0.618 mm (24.33 mils)
Inside Pattern: a=1.0 mm, x=0.495 mm (19.48 mils), y=0.858 mm (33.78 mils)

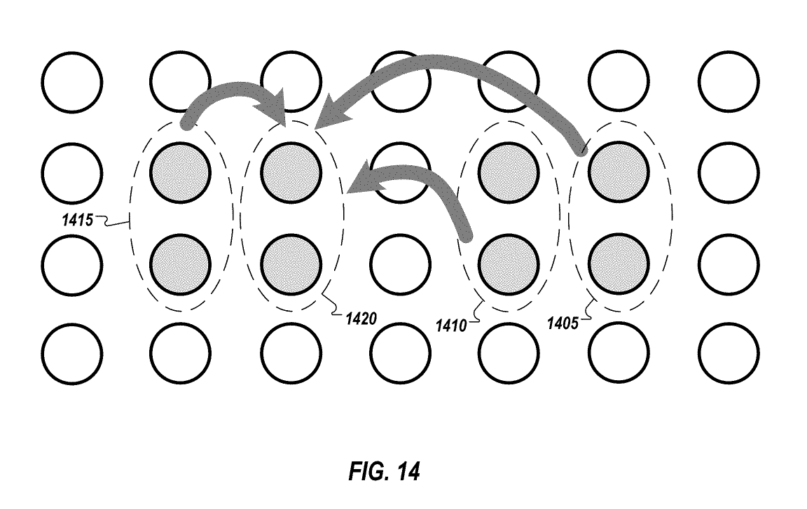

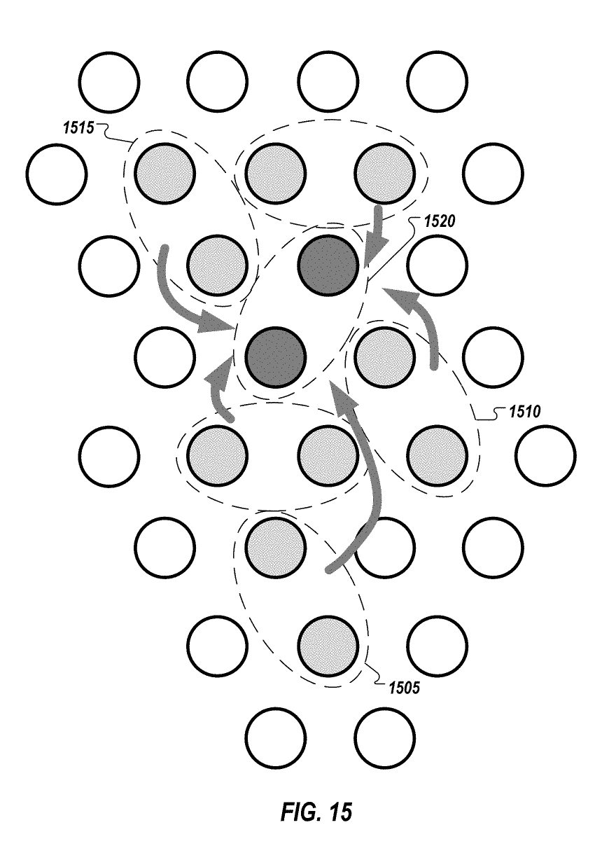

Turning to FIGS. 14 and 15, a hexagonal connector pattern can further be used to not only increase the pin density of a pinfield but also improve crosstalk characteristics of the retimer. FIG. 14 shows a portion of a grid-based pin pattern of a conventional retimer footprint. Differential pairs may be positioned, within such a design, as to be parallel with other differential pairs in the pinfield. Signaling on one of these differential pairs can cause crosstalk on neighboring pins. For instance, as shown in FIG. 14, signaling on differential pairs 1405, 1410, and 1415 can all contribute crosstalk noise to one or more victim pairs or lanes (e.g., 1420). Further, each of the differential pairs (e.g., 1405, 1410, 1415, 1420) can be “victim” lanes of crosstalk generated by signaling on neighboring lanes. Conventional designs may provide intermittent ground pins to assist in absorbing crosstalk energy, however these ground pins can claim valuable portions of the overall area of the footprint, leading to an overall increase in pin count and surface area of a pinfield.

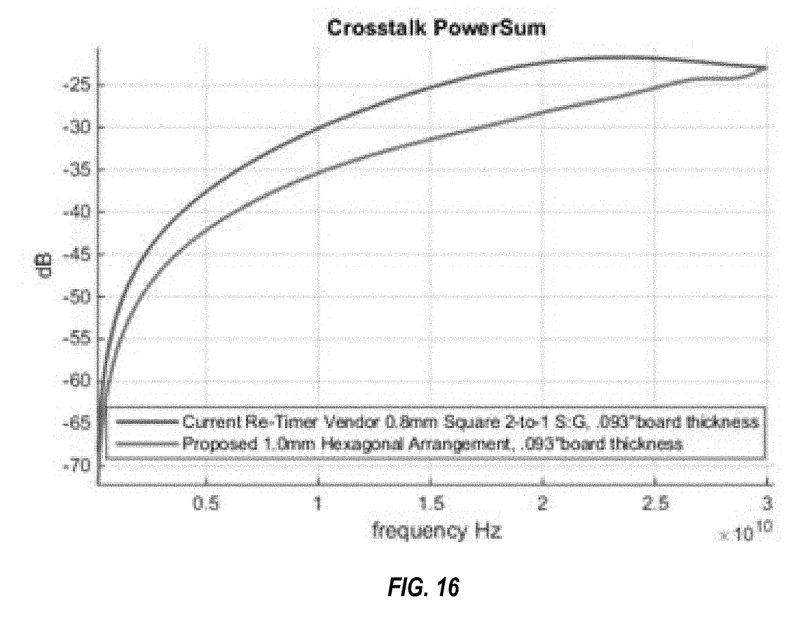

Turning to FIG. 15, a portion of a pinfield of an improved retimer footprint is shown, such as the standardized footprint discussed above. In this example, a hexagonal pinfield pattern is utilized facilitating orthogonal placement of differential signaling pairs relative to each other within the pinfield. Such a pattern and pin assignment is also illustrated in the pinfield examples of FIGS. 10-12B. While crosstalk may still occur, orthogonal placement of signaling pairs (e.g., 1505, 1510, 1515, etc.) can result in substantial improvement in crosstalk characteristics, as compared with parallel placement prevalent in grid-based pin patterns. For instance, as shown in the graph of FIG. 16, crosstalk present in a hexagonal pin patterned retimer footprint utilizing orthogonal signal pair placement is compared with crosstalk manifesting in a conventional grid-based retimer footprint. For instance, FIG. 16 illustrates the results of an example study performed using 3D modeling. For instance, models of each platform can be based on using the PCB via design that the respective device pinmap dictates. A typical 0.093″ thickness PCB design is used for the model. First, the conventional grid-based pattern is modeled with one victim and three nearest crosstalk aggressors (as illustrated in the representation of FIG. 14). Secondly, an orthogonal design is modeled (such as illustrated in the representation of FIG. 15). A victim pair (e.g., 1420, 1520) is assigned in each case with multiple crosstalk aggressors monitored to comprehend the total induced noise (e.g., number of aggressors can differ as there are fewer grounds). For instance, in one example, three crosstalk aggressors are modeled in the conventional design and five crosstalk aggressors are modeled in the improved design and the power sum of all the modeled aggressors is accumulated for both the conventional grid-based and the improved orthogonal designs. As illustrated in FIG. 16, the results show a 5 dB decrease in crosstalk power sum at 8 GHz, the Nyquist frequency for PCIe Gen-4 at 16 GT/s.

In addition to the features discussed above, a defined retimer standard can include further or alternative features such as:
Removal of TX capacitors from inside the package;
Swapping of TX and RX pin assignments to different form factor usages;
Removal of the two columns of ground pins that isolate TX signals from RX signals to provide further reduction in the number of pins in the proposed package; among other example features. In some instances, the defined standard can be specification-defined and set forth requirements to be adopted for a particular protocol or technology, such as PCIe, UPI, or another interconnect. Such definitions can simplify incorporation of retimers (even of varying lane widths) during system design and construction, particularly as system data rates increase and decrease maximum channel lengths achievable within a system without a retimer, redriver, or other channel-extending device.

Note that the apparatus', methods', and systems described above may be implemented in any electronic device or system as aforementioned. As specific illustrations, the figures below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

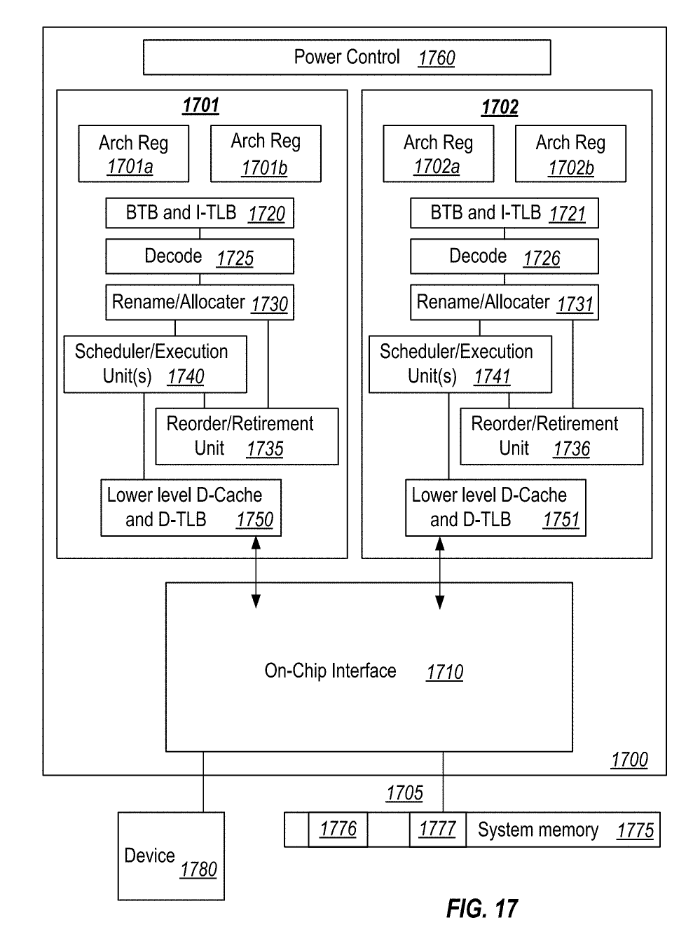

Referring to FIG. 17, an embodiment of a block diagram for a computing system including a multicore processor is depicted. Processor 1700 includes any processor or processing device, such as a microprocessor, an embedded processor, a digital signal processor (DSP), a network processor, a handheld processor, an application processor, a co-processor, a system on a chip (SOC), or other device to execute code. Processor 1700, in one embodiment, includes at least two cores—core 1701 and 1702, which may include asymmetric cores or symmetric cores (the illustrated embodiment). However, processor 1700 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1700, as illustrated in FIG. 17, includes two cores—core 1701 and 1702. Here, core 1701 and 1702 are considered symmetric cores, i.e. cores with the same configurations, functional units, and/or logic. In another embodiment, core 1701 includes an out-of-order processor core, while core 1702 includes an in-order processor core. However, cores 1701 and 1702 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 1701 are described in further detail below, as the units in core 1702 operate in a similar manner in the depicted embodiment.

As depicted, core 1701 includes two hardware threads 1701a and 1701b, which may also be referred to as hardware thread slots 1701a and 1701b. Therefore, software entities, such as an operating system, in one embodiment potentially view processor 1700 as four separate processors, i.e., four logical processors or processing elements capable of executing four software threads concurrently. As alluded to above, a first thread is associated with architecture state registers 1701a, a second thread is associated with architecture state registers 1701b, a third thread may be associated with architecture state registers 1702a, and a fourth thread may be associated with architecture state registers 1702b. Here, each of the architecture state registers (1701a, 1701b, 1702a, and 1702b ) may be referred to as processing elements, thread slots, or thread units, as described above. As illustrated, architecture state registers 1701a are replicated in architecture state registers 1701b, so individual architecture states/contexts are capable of being stored for logical processor 1701a and logical processor 1701b. In core 1701, other smaller resources, such as instruction pointers and renaming logic in allocator and renamer block 1730 may also be replicated for threads 1701a and 1701b. Some resources, such as re-order buffers in reorder/retirement unit 1735, ILTB 1720, load/store buffers, and queues may be shared through partitioning. Other resources, such as general purpose internal registers, page-table base register(s), low-level data-cache and data-TLB 1715, execution unit(s) 1740, and portions of out-of-order unit 1735 are potentially fully shared.

Processor 1700 often includes other resources, which may be fully shared, shared through partitioning, or dedicated by/to processing elements. In FIG. 17, an embodiment of a purely exemplary processor with illustrative logical units/resources of a processor is illustrated. Note that a processor may include, or omit, any of these functional units, as well as include any other known functional units, logic, or firmware not depicted. As illustrated, core 1701 includes a simplified, representative out-of-order (OOO) processor core. But an in-order processor may be utilized in different embodiments. The OOO core includes a branch target buffer 1720 to predict branches to be executed/taken and an instruction-translation buffer (I-TLB) 1720 to store address translation entries for instructions.

Core 1701 further includes decode module 1725 coupled to fetch unit 1720 to decode fetched elements. Fetch logic, in one embodiment, includes individual sequencers associated with thread slots 1701a, 1701b, respectively. Usually core 1701 is associated with a first ISA, which defines/specifies instructions executable on processor 1700. Often machine code instructions that are part of the first ISA include a portion of the instruction (referred to as an opcode), which references/specifies an instruction or operation to be performed. Decode logic 1725 includes circuitry that recognizes these instructions from their opcodes and passes the decoded instructions on in the pipeline for processing as defined by the first ISA. For example, as discussed in more detail below decoders 1725, in one embodiment, include logic designed or adapted to recognize specific instructions, such as transactional instruction. As a result of the recognition by decoders 1725, the architecture or core 1701 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 1726, in one embodiment, recognize the same ISA (or a subset thereof). Alternatively, in a heterogeneous core environment, decoders 1726 recognize a second ISA (either a subset of the first ISA or a distinct ISA).

In one example, allocator and renamer block 1730 includes an allocator to reserve resources, such as register files to store instruction processing results. However, threads 1701a and 1701b are potentially capable of out-of-order execution, where allocator and renamer block 1730 also reserves other resources, such as reorder buffers to track instruction results. Unit 1730 may also include a register renamer to rename program/instruction reference registers to other registers internal to processor 1700. Reorder/retirement unit 1735 includes components, such as the reorder buffers mentioned above, load buffers, and store buffers, to support out-of-order execution and later in-order retirement of instructions executed out-of-order.

Scheduler and execution unit(s) block 1740, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1750 are coupled to execution unit(s) 1740. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1701 and 1702 share access to higher-level or further-out cache, such as a second level cache associated with on-chip interface 1710. Note that higher-level or further-out refers to cache levels increasing or getting further way from the execution unit(s). In one embodiment, higher-level cache is a last-level data cache—last cache in the memory hierarchy on processor 1700—such as a second or third level data cache. However, higher level cache is not so limited, as it may be associated with or include an instruction cache. A trace cache—a type of instruction cache—instead may be coupled after decoder 1725 to store recently decoded traces. Here, an instruction potentially refers to a macro-instruction (i.e. a general instruction recognized by the decoders), which may decode into a number of micro-instructions (micro-operations).

In the depicted configuration, processor 1700 also includes on-chip interface module 1710. Historically, a memory controller, which is described in more detail below, has been included in a computing system external to processor 1700. In this scenario, on-chip interface 1710 is to communicate with devices external to processor 1700, such as system memory 1775, a chipset (often including a memory controller hub to connect to memory 1775 and an I/O controller hub to connect peripheral devices), a memory controller hub, a northbridge, or other integrated circuit. And in this scenario, bus 1705 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1775 may be dedicated to processor 1700 or shared with other devices in a system. Common examples of types of memory 1775 include DRAM, SRAM, non-volatile memory (NV memory), and other known storage devices. Note that device 1780 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 1700. For example in one embodiment, a memory controller hub is on the same package and/or die with processor 1700. Here, a portion of the core (an on-core portion) 1710 includes one or more controller(s) for interfacing with other devices such as memory 1775 or a graphics device 1780. The configuration including an interconnect and controllers for interfacing with such devices is often referred to as an on-core (or un-core configuration). As an example, on-chip interface 1710 includes a ring interconnect for on-chip communication and a high-speed serial point-to-point link 1705 for off-chip communication. Yet, in the SOC environment, even more devices, such as the network interface, co-processors, memory 1775, graphics processor 1780, and any other known computer devices/interface may be integrated on a single die or integrated circuit to provide small form factor with high functionality and low power consumption.

In one embodiment, processor 1700 is capable of executing a compiler, optimization, and/or translator code 1777 to compile, translate, and/or optimize application code 1776 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

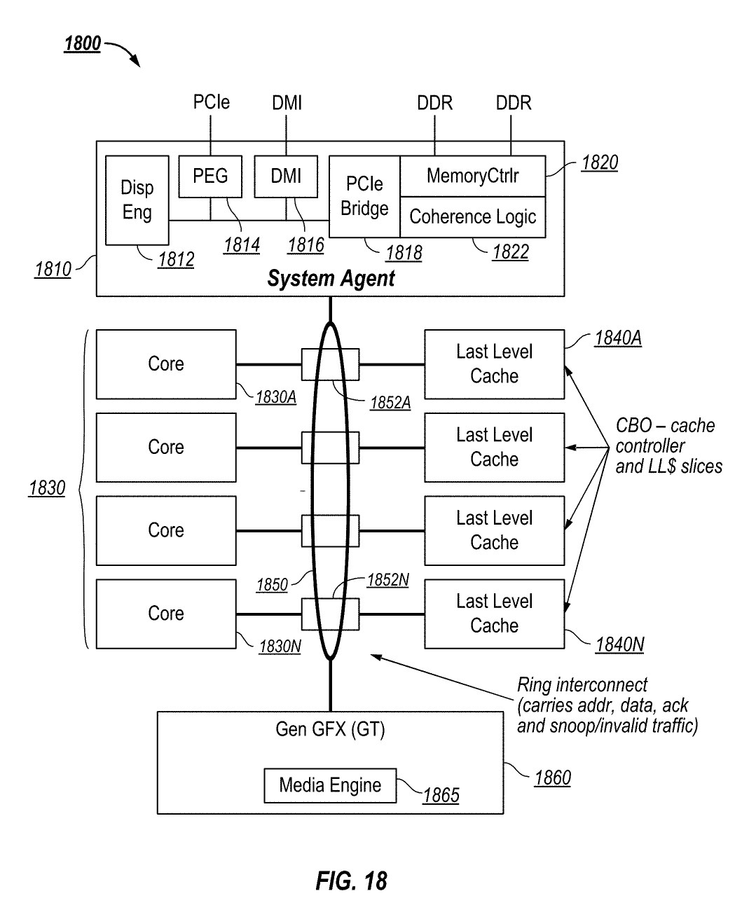

Referring now to FIG. 18, shown is a block diagram of an embodiment of a multicore processor. As shown in the embodiment of FIG. 18, processor 1800 includes multiple domains. Specifically, a core domain 1830 includes a plurality of cores 1830A-1830N, a graphics domain 1860 includes one or more graphics engines having a media engine 1865, and a system agent domain 1810.

In various embodiments, system agent domain 1810 handles power control events and power management, such that individual units of domains 1830 and 1860 (e.g. cores and/or graphics engines) are independently controllable to dynamically operate at an appropriate power mode/level (e.g. active, turbo, sleep, hibernate, deep sleep, or other Advanced Configuration Power Interface like state) in light of the activity (or inactivity) occurring in the given unit. Each of domains 1830 and 1860 may operate at different voltage and/or power, and furthermore the individual units within the domains each potentially operate at an independent frequency and voltage. Note that while only shown with three domains, understand the scope of the present invention is not limited in this regard and additional domains may be present in other embodiments.

As shown, each core 1830 further includes low level caches in addition to various execution units and additional processing elements. Here, the various cores are coupled to each other and to a shared cache memory that is formed of a plurality of units or slices of a last level cache (LLC) 1840A-1840N; these LLCs often include storage and cache controller functionality and are shared amongst the cores, as well as potentially among the graphics engine too.

As seen, a ring interconnect 1850 couples the cores together, and provides interconnection between the core domain 1830, graphics domain 1860 and system agent circuitry 1810, via a plurality of ring stops 1852A-1852N, each at a coupling between a core and LLC slice. As seen in FIG. 18, interconnect 1850 is used to carry various information, including address information, data information, acknowledgement information, and snoop/invalid information. Although a ring interconnect is illustrated, any known on-die interconnect or fabric may be utilized. As an illustrative example, some of the fabrics discussed above (e.g. another on-die interconnect, On-chip System Fabric (OSF), an Advanced Microcontroller Bus Architecture (AMBA) interconnect, a multi-dimensional mesh fabric, or other known interconnect architecture) may be utilized in a similar fashion.

As further depicted, system agent domain 1810 includes display engine 1812 which is to provide control of and an interface to an associated display. System agent domain 1810 may include other units, such as: an integrated memory controller 1820 that provides for an interface to a system memory (e.g., a DRAM implemented with multiple DIMMs; coherence logic 1822 to perform memory coherence operations. Multiple interfaces may be present to enable interconnection between the processor and other circuitry. For example, in one embodiment at least one direct media interface (DMI) 1816 interface is provided as well as one or more PCIe™ interfaces 1814. The display engine and these interfaces typically couple to memory via a PCIe™ bridge 1818. Still further, to provide for communications between other agents, such as additional processors or other circuitry, one or more other interfaces may be provided.

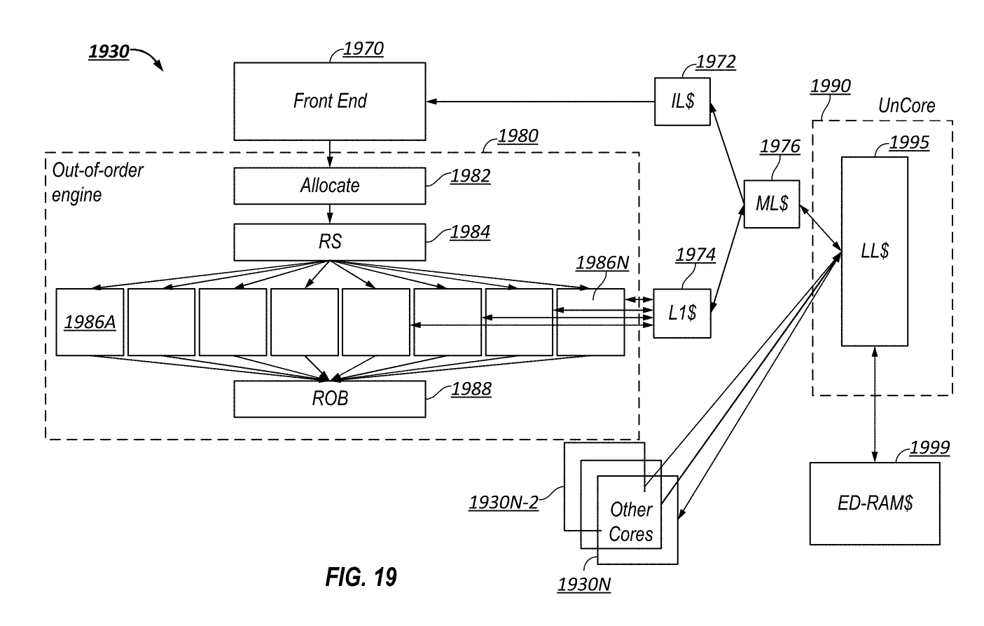

Referring now to FIG. 19, shown is a block diagram of a representative core; specifically, logical blocks of a back-end of a core, such as core 1830 from FIG. 18. In general, the structure shown in FIG. 19 includes an out-of-order processor that has a front end unit 1970 used to fetch incoming instructions, perform various processing (e.g. caching, decoding, branch predicting, etc.) and passing instructions/operations along to an out-of-order (OOO) engine 1980. OOO engine 1980 performs further processing on decoded instructions.

Specifically in the embodiment of FIG. 19, out-of-order engine 1980 includes an allocate unit 1982 to receive decoded instructions, which may be in the form of one or more micro-instructions or uops, from front end unit 1970, and allocate them to appropriate resources such as registers and so forth. Next, the instructions are provided to a reservation station 1984, which reserves resources and schedules them for execution on one of a plurality of execution units 1986A-1986N. Various types of execution units may be present, including, for example, arithmetic logic units (ALUs), load and store units, vector processing units (VPUs), floating point execution units, among others. Results from these different execution units are provided to a reorder buffer (ROB) 1988, which take unordered results and return them to correct program order.

Still referring to FIG. 19, note that both front end unit 1970 and out-of-order engine 1980 are coupled to different levels of a memory hierarchy. Specifically shown is an instruction level cache 1972, that in turn couples to a mid-level cache 1976, that in turn couples to a last level cache 1995. In one embodiment, last level cache 1995 is implemented in an on-chip (sometimes referred to as uncore) unit 1990. As an example, unit 1990 is similar to system agent 1810 of FIG. 18. As discussed above, uncore 1990 communicates with system memory 1999, which, in the illustrated embodiment, is implemented via ED RAM. Note also that the various execution units 1986 within out-of-order engine 1980 are in communication with a first level cache 1974 that also is in communication with mid-level cache 1976. Note also that additional cores 1930N-2-1930N can couple to LLC 1995. Although shown at this high level in the embodiment of FIG. 19, understand that various alterations and additional components may be present.

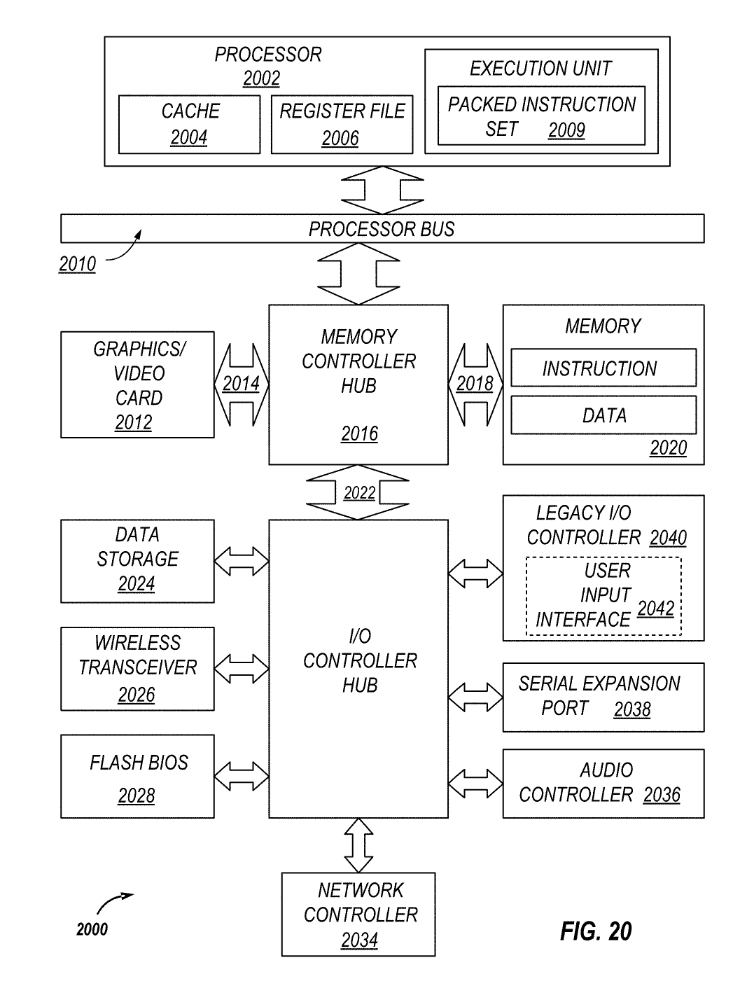

Turning to FIG. 20, a block diagram of an exemplary computer system formed with a processor that includes execution units to execute an instruction, where one or more of the interconnects implement one or more features in accordance with one embodiment of the present invention is illustrated. System 2000 includes a component, such as a processor 2002 to employ execution units including logic to perform algorithms for process data, in accordance with the present invention, such as in the embodiment described herein. System 2000 is representative of processing systems based on the PENTIUM III™, PENTIUM 4™, Xeon™, Itanium, XScale™ and/or StrongARM™ microprocessors, although other systems (including PCs having other microprocessors, engineering workstations, set-top boxes and the like) may also be used. In one embodiment, sample system 2000 executes a version of the WINDOWS™ operating system available from Microsoft Corporation of Redmond, Washington, although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 2002 includes one or more execution units 2008 to implement an algorithm that is to perform at least one instruction. One embodiment may be described in the context of a single processor desktop or server system, but alternative embodiments may be included in a multiprocessor system. System 2000 is an example of a ‘hub’ system architecture. The computer system 2000 includes a processor 2002 to process data signals. The processor 2002, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 2002 is coupled to a processor bus 2010 that transmits data signals between the processor 2002 and other components in the system 2000. The elements of system 2000 (e.g. graphics accelerator 2012, memory controller hub 2016, memory 2020, I/O controller hub 2024, wireless transceiver 2026, Flash BIOS 2028, Network controller 2034, Audio controller 2036, Serial expansion port 2038, I/O controller 2040, etc.) perform their conventional functions that are well known to those familiar with the art.

In one embodiment, the processor 2002 includes a Level 1 (L1) internal cache memory 2004. Depending on the architecture, the processor 2002 may have a single internal cache or multiple levels of internal caches. Other embodiments include a combination of both internal and external caches depending on the particular implementation and needs. Register file 2006 is to store different types of data in various registers including integer registers, floating point registers, vector registers, banked registers, shadow registers, checkpoint registers, status registers, and instruction pointer register.

Execution unit 2008, including logic to perform integer and floating point operations, also resides in the processor 2002. The processor 2002, in one embodiment, includes a microcode (ucode) ROM to store microcode, which when executed, is to perform algorithms for certain macroinstructions or handle complex scenarios. Here, microcode is potentially updateable to handle logic bugs/fixes for processor 2002. For one embodiment, execution unit 2008 includes logic to handle a packed instruction set 2009. By including the packed instruction set 2009 in the instruction set of a general-purpose processor 2002, along with associated circuitry to execute the instructions, the operations used by many multimedia applications may be performed using packed data in a general-purpose processor 2002. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 2008 may also be used in micro controllers, embedded processors, graphics devices, DSPs, and other types of logic circuits. System 2000 includes a memory 2020. Memory 2020 includes a dynamic random access memory (DRAM) device, a static random access memory (SRAM) device, flash memory device, or other memory device. Memory 2020 stores instructions and/or data represented by data signals that are to be executed by the processor 2002.

Note that any of the aforementioned features or aspects of the invention may be utilized on one or more interconnect illustrated in FIG. 20. For example, an on-die interconnect (ODI), which is not shown, for coupling internal units of processor 2002 implements one or more aspects of the invention described above. Or the invention is associated with a processor bus 2010 (e.g. other known high performance computing interconnect), a high bandwidth memory path 2018 to memory 2020, a point-to-point link to graphics accelerator 2012 (e.g. a Peripheral Component Interconnect express (PCIe) compliant fabric), a controller hub interconnect 2022, an I/O or other interconnect (e.g. USB, PCI, PCIe) for coupling the other illustrated components. Some examples of such components include the audio controller 2036, firmware hub (flash BIOS) 2028, wireless transceiver 2026, data storage 2024, legacy I/O controller 2010 containing user input and keyboard interfaces 2042, a serial expansion port 2038 such as Universal Serial Bus (USB), and a network controller 2034. The data storage device 2024 can comprise a hard disk drive, a floppy disk drive, a CD-ROM device, a flash memory device, or other mass storage device.

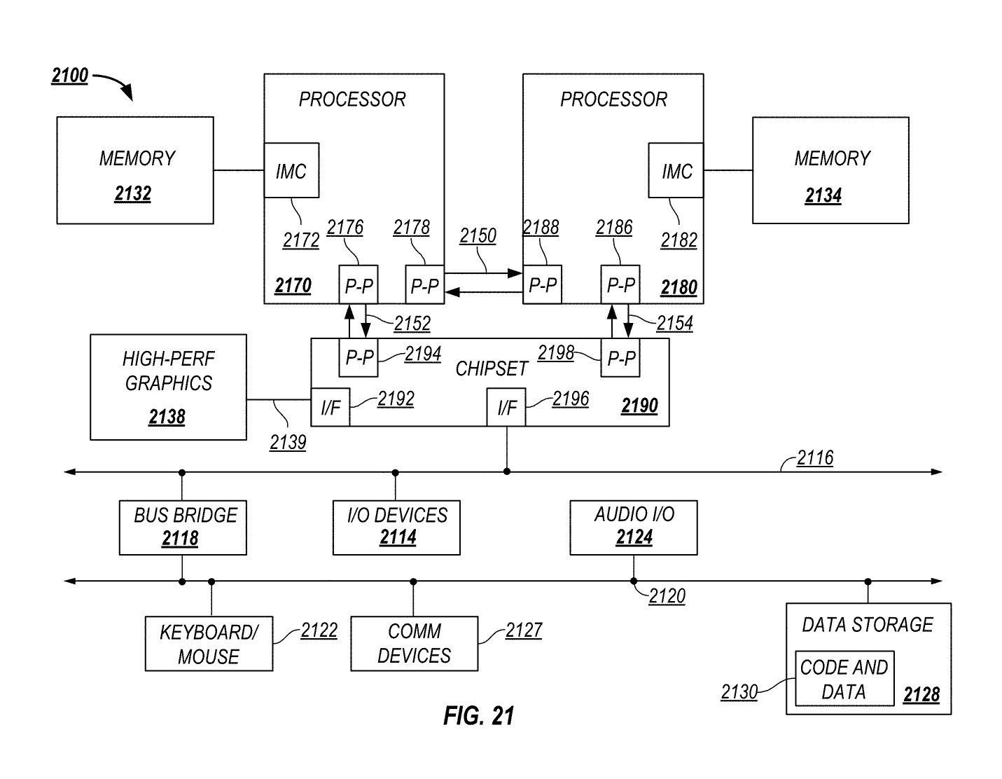

Referring now to FIG. 21, shown is a block diagram of a second system 2100 in accordance with an embodiment of the present invention. As shown in FIG. 21, multiprocessor system 2100 is a point-to-point interconnect system, and includes a first processor 2170 and a second processor 2180 coupled via a point-to-point interconnect 2150. Each of processors 2170 and 2180 may be some version of a processor. In one embodiment, 2152 and 2154 are part of a serial, point-to-point coherent interconnect fabric, such as a high-performance architecture. As a result, the invention may be implemented within the QPI architecture.

While shown with only two processors 2170, 2180, it is to be understood that the scope of the present invention is not so limited. In other embodiments, one or more additional processors may be present in a given processor.

Processors 2170 and 2180 are shown including integrated memory controller units 2172 and 2182, respectively. Processor 2170 also includes as part of its bus controller units point-to-point (P-P) interfaces 2176 and 2178; similarly, second processor 2180 includes P-P interfaces 2186 and 2188. Processors 2170, 2180 may exchange information via a point-to-point (P-P) interface 2150 using P-P interface circuits 2178, 2188. As shown in FIG. 21, IMCs 2172 and 2182 couple the processors to respective memories, namely a memory 2132 and a memory 2134, which may be portions of main memory locally attached to the respective processors.

Processors 2170, 2180 each exchange information with a chipset 2190 via individual P-P interfaces 2152, 2154 using point to point interface circuits 2176, 2194, 2186, 2198. Chipset 2190 also exchanges information with a high-performance graphics circuit 2138 via an interface circuit 2192 along a high-performance graphics interconnect 2139.

A shared cache (not shown) may be included in either processor or outside of both processors; yet connected with the processors via P-P interconnect, such that either or both processors' local cache information may be stored in the shared cache if a processor is placed into a low power mode.

Chipset 2190 may be coupled to a first bus 2116 via an interface 2196. In one embodiment, first bus 2116 may be a Peripheral Component Interconnect (PCI) bus, or a bus such as a PCI Express bus or another third generation I/O interconnect bus, although the scope of the present invention is not so limited.

As shown in FIG. 21, various I/O devices 2114 are coupled to first bus 2116, along with a bus bridge 2118 which couples first bus 2116 to a second bus 2120. In one embodiment, second bus 2120 includes a low pin count (LPC) bus. Various devices are coupled to second bus 2120 including, for example, a keyboard and/or mouse 2122, communication devices 2127 and a storage unit 2128 such as a disk drive or other mass storage device which often includes instructions/code and data 2130, in one embodiment. Further, an audio I/O 2124 is shown coupled to second bus 2120. Note that other architectures are possible, where the included components and interconnect architectures vary. For example, instead of the point-to-point architecture of FIG. 21, a system may implement a multi-drop bus or other such architecture.

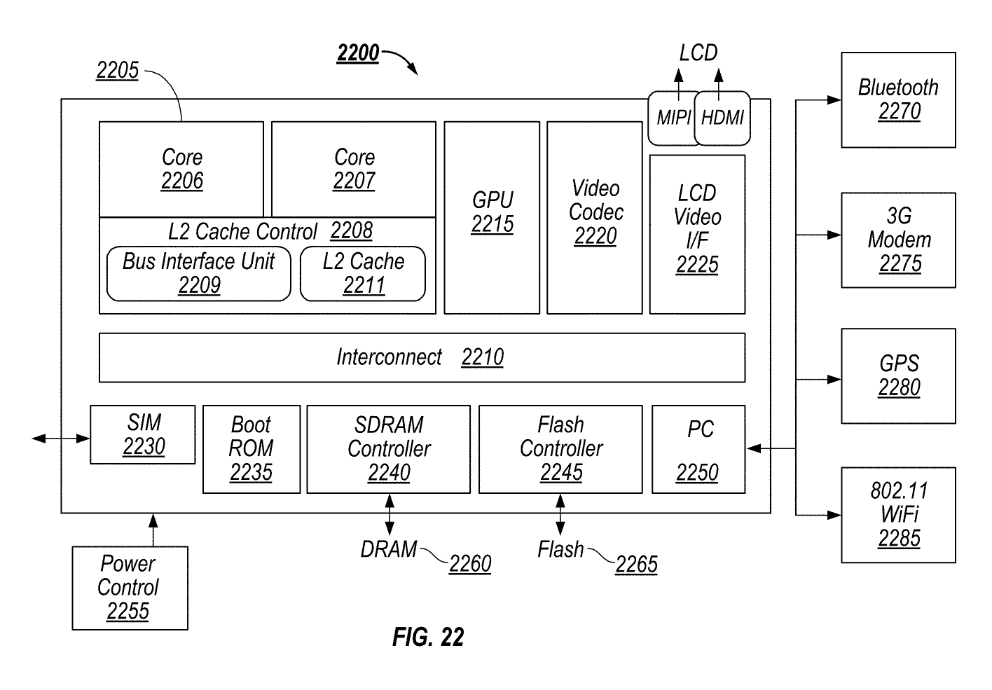

Turning next to FIG. 22, an embodiment of a system on-chip (SOC) design in accordance with the inventions is depicted. As a specific illustrative example, SOC 2200 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 2200 includes 2 cores-2206 and 2207. Similar to the discussion above, cores 2206 and 2207 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 2206 and 2207 are coupled to cache control 2208 that is associated with bus interface unit 2209 and L2 cache 2211 to communicate with other parts of system 2200. Interconnect 2210 includes an on-chip interconnect, such as an IOSF, AMBA, or other interconnect discussed above, which potentially implements one or more aspects of described herein.

Interface 2210 provides communication channels to the other components, such as a Subscriber Identity Module (SIM) 2230 to interface with a SIM card, a boot rom 2235 to hold boot code for execution by cores 2206 and 2207 to initialize and boot SOC 2200, a SDRAM controller 2240 to interface with external memory (e.g. DRAM 2260), a flash controller 2245 to interface with non-volatile memory (e.g. Flash 2265), a peripheral control 2250 (e.g. Serial Peripheral Interface) to interface with peripherals, video codecs 2220 and Video interface 2225 to display and receive input (e.g. touch enabled input), GPU 2215 to perform graphics related computations, etc. Any of these interfaces may incorporate aspects of the invention described herein.

In addition, the system illustrates peripherals for communication, such as a Bluetooth module 2270, 3G modem 2275, GPS 2285, and WiFi 2285. Note as stated above, a UE includes a radio for communication. As a result, these peripheral communication modules are not all required. However, in a UE some form a radio for external communication is to be included.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a chip package including: a retimer and an array of connectors on a surface of the chip package, where the array of connectors is configured to form a ball grid array to electrically connect the chip package to a circuit board, where at least a portion of the connectors in the array are arranged on the surface in a hexagonal pattern.

Example 2 may include the subject matter of example 1, where the array includes at least two regions, connectors in a first one of the regions are arranged in a first hexagonal pattern including a first diagonal pitch, and connectors in a second one of the regions are arranged in a second hexagonal pattern including a different, second diagonal pitch.

Example 3 may include the subject matter of example 2, where the first region includes at least two sides of an outside border of the array and the first diagonal pitch is less than the second diagonal pitch.

Example 4 may include the subject matter of example 3, where the connectors of the second region include connectors for high speed differential pairs of the retimer.

Example 5 may include the subject matter of example 3, where the second region includes a predominantly interior region of the pattern and the first region includes a predominantly exterior region of the pattern.

Example 6 may include the subject matter of example 1, where all connectors in the array are arranged hexagonally.

Example 7 may include the subject matter of example 1, where connectors in each row of connectors in the hexagonal pattern are not aligned vertically with connectors in immediately adjacent rows and connectors in each column of connectors in the hexagonal pattern are not aligned horizontally with connectors in immediately adjacent columns.

Example 8 may include the subject matter of example 1, where the array of connectors includes connectors respectively assigned to a plurality of high speed differential pairs.

Example 9 may include the subject matter of example 8, where the connectors are assigned to the plurality of high speed connectors to arrange each high speed differential pair in the plurality of high speed differential pairs substantially orthogonally with respect to one or more other differential pairs in the plurality of high speed differential pairs.

Example 10 may include the subject matter of example 1, where the array is according to a standard defined for retimers of a particular interconnect protocol.

Example 11 may include the subject matter of example 10, where the particular interconnect protocol includes Peripheral Component Interconnect Express (PCIe).

Example 12 may include the subject matter of example 10, where the standard defines a maximum first dimension for a footprint of the array, and a variable second dimension for the footprint.

Example 13 may include the subject matter of example 12, where the second dimension is to be increased to accommodate increasing retimer lane widths.

Example 14 may include the subject matter of example 10, where the standard defines connector arrays for at least 4-lane, 8-lane, and 16-lane widths of the retimer.

Example 15 may include the subject matter of example 14, where the defined connector arrays for the 4-lane, 8-lane, and 16-lane widths include overlapping connector assignments.

Example 16 is a method including: receiving, at a retimer device, a signal from a first device transmitted on a plurality of lanes, where the retimer device includes a plurality of connectors to connect to the plurality of lanes, the plurality of connectors are physically arranged in a hexagonal pattern, each lane includes a respective differential signaling pair, and each differential signaling pair is assigned to a pair of connectors in the plurality of connectors to be arranged substantially orthogonally with respect to connectors in the plurality of connectors assigned to at least another one of the differential signaling pairs; regenerating the signal; and sending the regenerated signal to a second device.

Example 17 is a system including: a circuit board and a chip package connected to the circuit board, the chip package including: a retimer; and an array of connectors on a surface of the chip package, where the array of connectors is configured to form a ball grid array to electrically connect the chip package to the circuit board, where at least a portion of the connectors in the array are arranged on the surface in a hexagonal pattern.

Example 18 may include the subject matter of example 17, further including two devices connected over a link including the retimer and at least one of the two devices is mounted to the circuit board.

Example 19 may include the subject matter of example 17, further including alternating current (AC) coupling capacitors.

Example 20 may include the subject matter of example 17, where the circuit board includes a riser.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a chip package comprising:
a retimer; and
an array of connectors on a surface of the chip package, wherein the array of connectors is configured to form a ball grid array to electrically connect the chip package to a circuit board, wherein at least a portion of the connectors in the array are arranged on the surface in a hexagonal pattern.

2. The apparatus of claim 1, wherein the array comprises at least two regions, connectors in a first one of the regions are arranged in a first hexagonal pattern comprising a first diagonal pitch, and connectors in a second one of the regions are arranged in a second hexagonal pattern comprising a different, second diagonal pitch.

3. The apparatus of claim 2, wherein the first region comprises at least two sides of an outside border of the array and the first diagonal pitch is less than the second diagonal pitch.

4. The apparatus of claim 3, wherein the connectors of the second region comprise connectors for high speed differential pairs of the retimer.

5. The apparatus of claim 3, wherein the second region comprises a predominantly interior region of the pattern and the first region comprises a predominantly exterior region of the pattern.

6. The apparatus of claim 1, wherein all connectors in the array are arranged hexagonally.

7. The apparatus of claim 1, wherein connectors in each row of connectors in the hexagonal pattern are not aligned vertically with connectors in immediately adjacent rows and connectors in each column of connectors in the hexagonal pattern are not aligned horizontally with connectors in immediately adjacent columns.

8. The apparatus of claim 1, wherein the array of connectors comprises connectors respectively assigned to a plurality of high speed differential pairs.

9. The apparatus of claim 8, wherein the connectors are assigned to the plurality of high speed connectors to arrange each high speed differential pair in the plurality of high speed differential pairs substantially orthogonally with respect to one or more other differential pairs in the plurality of high speed differential pairs.

10. The apparatus of claim 1, wherein the array is according to a standard defined for retimers of a particular interconnect protocol.

11. The apparatus of claim 10, wherein the particular interconnect protocol comprises Peripheral Component Interconnect Express (PCIe).

12. The apparatus of claim 10, wherein the standard defines a maximum first dimension for a footprint of the array, and a variable second dimension for the footprint.

13. The apparatus of claim 12, wherein the second dimension is to be increased to accommodate increasing retimer lane widths.

14. The apparatus of claim 10, wherein the standard defines connector arrays for at least 4-lane, 8-lane, and 16-lane widths of the retimer.

15. The apparatus of claim 14, wherein the defined connector arrays for the 4-lane, 8-lane, and 16-lane widths comprise overlapping connector assignments.

16. A method comprising:
receiving, at a retimer device, a signal from a first device transmitted on a plurality of lanes, wherein the retimer device comprises a plurality of connectors to connect to the plurality of lanes, the plurality of connectors are physically arranged in a hexagonal pattern, each lane comprises a respective differential signaling pair, and each differential signaling pair is assigned to a pair of connectors in the plurality of connectors to be arranged substantially orthogonally with respect to connectors in the plurality of connectors assigned to at least another one of the differential signaling pairs;
regenerating the signal; and
sending the regenerated signal to a second device.

17. A system comprising:
a circuit board; and
a chip package connected to the circuit board, the chip package comprising:
a retimer; and
an array of connectors on a surface of the chip package, wherein the array of connectors is configured to form a ball grid array to electrically connect the chip package to the circuit board, wherein at least a portion of the connectors in the array are arranged on the surface in a hexagonal pattern.

18. The system of claim 17, further comprising two devices connected over a link comprising the retimer and at least one of the two devices is mounted to the circuit board.

19. The system of claim 17, further comprising alternating current (AC) coupling capacitors.

20. The system of claim 17, wherein the circuit board comprises a riser.
